(19) United States
(12) Patent Application Publication
(10) Pub. No.: US 2006/0104227 A1
(43) Pub. Date: May 18, 2006

(54) Data communication methods and systems

(76) Inventor: Chia-En Chuang, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/989,091

(22) Filed: Nov. 15, 2004

(51) Int. Cl. H04Q 7/00

(52) U.S. Cl. 370/328

(57) ABSTRACT

Data communication methods and systems for a host computer to access communication via a radio device. The current computations are interrupted when the host computer receives an interrupt signal, radio frequency (RF) control signals, and baseband data signals from the radio device. The host computer processes modem tasks and performs relative computation operations to obtain computation results, and sends the computation result back to the radio device.

### BACKGROUND

The invention relates to data communication, and more specifically, to methods and systems for a host computer to access data communication through a radio device.

Several radio devices are available that can be directly connected to the serial interface port of a host computer for wireless communication. The radio device connected to the host computer serves as a wireless radio frequency (RF) modem for the host computer. Examples of radio devices include mobile phones and personal digital assistants (PDAs), which provide wireless connection and data communication to the host computer through cellular technologies such as Global Systems for Mobiles (GSM), General Packet Radio Service (GPRS), and Code Division Multiple Access (CDMA). The radio device typically comprises a RF front end, a baseband processing unit, a central processing unit (CPU), a memory, and an interface.

FIG. 1 illustrates a data communication system comprising a host computer 10 connected to a radio device 12. The host computer 10 may typically be a personal computer (PC), a laptop, a PDA, a point of sale terminal, or some other computing system. Typical interfaces between the host computer 10 and the radio device 12 may be RS-232, Universal Serial Bus (USB), Universal Asynchronous receiver/transmitter (UART), Personal Computer Memory Card International Association (PCMCIA) wireless card, or Compact Flash. The radio device 12 comprises a processor 121, an external memory 122, A/D (analog to digital) and D/A (digital to analog) converters 123, a modulator and demodulator 124, band pass filters (BPF) 125, a power amplifier (PA) 126, and an uplink/downlink multiplexer 127. The processor 121 comprises a microprocessor (μP) 1211, a digital signal processor (DSP) 1212, a PC interface 1213, a timing control unit (TCU) 1214, and a μP control interface 1215. In a receiving mode, the modem components work collectively to receive an electromagnetic RF signal containing information to be extracted. In a transmitting mode, the modem components work collectively to transmit an electromagnetic RF signal containing information to be transmitted.

The modem components collectively operate to perform main modem tasks including RF conversion, baseband processing, and protocol stack control tasks. RF conversion tasks include preparation of the RF signal received at the antenna for demodulation and preparation of the modulated baseband analog signal for transmission. Baseband processing tasks include demodulation of the modulated baseband analog signal to extract a plurality of data bits that correspond to the information being received, and generation of the modulated baseband analog signal from a plurality of data bits to be transmitted.

Data bits being transmitted are wrapped with protocol bits of data to facilitate transmission, routing, and reception of the data bits. Likewise, the protocol data must be removed to accurately reproduce, in the receiving RF modem, the data that was sent. The addition and stripping of the protocol bits are referred to as protocol stack control tasks, which are performed by the processor 121 in the radio device 12 under the control of a protocol stack software program stored in the external memory 122. The external memory 122 may be a Read Only Memory (ROM) or Random Access Memory (RAM). The PC interface 1213 then provides the reproduced data bits that were extracted from the RF signal to the computer 10, and receives the data bits from the computer 10 for processing and transmission.

### SUMMARY

Data communication methods ad systems are provided. Some embodiments provide a data communication method for a host computer, the method comprising receiving an interrupt signal, radio frequency (RF) control signals, and baseband data signals from a radio device coupled to the host computer; and interrupting current computations to process modem tasks for the received signals and perform relative computation operations to obtain computation results upon receiving the interrupt signal. The computation results are transmitted to the radio device. The modem tasks may be tasks originally performed by the DSP and microprocessor of the radio device, such as DSP tasks, layer 1 tasks, and protocol tasks.

Some embodiments of a data communication system comprise a radio device and a host computer. The radio device receives and transmits signals through a cellular technology, and performs signal processing to obtain RF control signals and baseband data signals. The radio device generates an interrupt signal and provides the interrupt signal together with the RF control signals and baseband data-signals to the host computer. The host computer interrupts current computations to process modem tasks for the received signals from the radio device, and performs relative computation operations to obtain computation results upon receiving the interrupt signal. The host computer then transmits the computation results to the radio device.

### DESCRIPTION OF THE DRAWINGS

The invention can be more fully understood by reading the subsequent detailed description in conjunction with the examples and references made to the accompanying drawings, wherein:

FIG. 1 shows a conventional data communication system for a host computer to access wireless communication through a radio device.

FIG. 2 illustrates a software configuration of an embodiment of a data communication system.

FIG. 3 shows an embodiment of a data communication system for a host computer accessing wireless communication through a radio device.

FIG. 4 illustrates an embodiment of a processor in a radio device providing data communication for a host computer.

### DETAILED DESCRIPTION

Methods and systems for a host computer to access data communication through a radio device are provided and described in detail in the following. A host computer connected to a radio device, for example, a mobile phone, accesses the Internet by a cellular technology. Communication tasks and computations performed by the radio device are similar to a modem, which typically include RF conversion, baseband processing, and protocol stack control tasks. The radio device requires that the received data be decoded to IP layer. The destination address and port of each packet must then be determined and wrapped with protocol bits before transmission to the host computer. Thus a significant amount of complicated computations for data processing before transmission and after reception of data from the host computer is required. Since resources of the host computer including processing speed and memory capacity usually exceed the resources of the radio device, embodiments of a data communication method and system shift a portion of data processing computations from the radio device to the host computer.

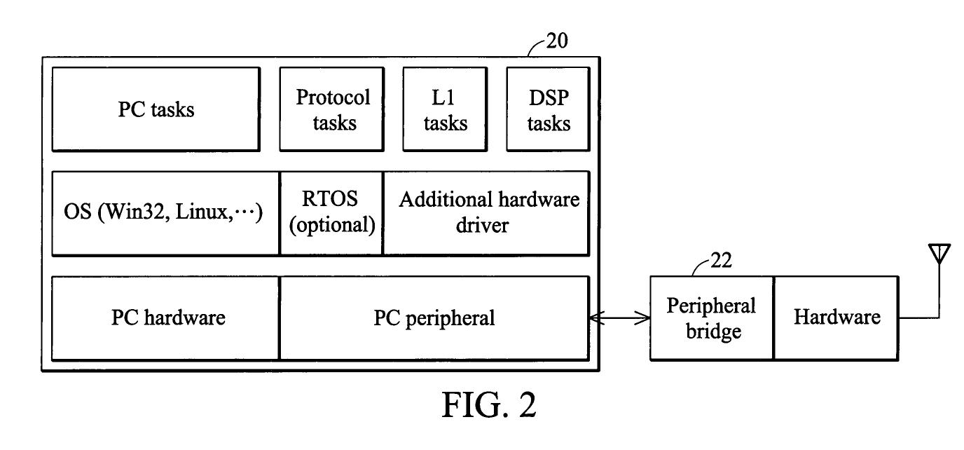

FIG. 2 shows a software configuration of an embodiment of the data communication system. A host computer 20 wirelessly accesses the Internet via a radio device 22. Modem tasks such as protocol tasks, Layer 1 (L1) tasks, and DSP tasks are data processing computations typically processed by a modem, or the radio device 22, are processed by the host computer 20 in the present embodiment. Protocol Tasks include signal processing related to the communication protocol, L1 tasks include execution of tasks related to the physical layer (Layer 1) of the communication system, and DSP tasks include mathematical computations required during the communication process. DSP tasks are originally performed by the DSP of the radio device 22, including multi-path decoding for the received RF signal. The host computer 20 processes these modem tasks via the operating system (OS), and if the OS is not capable of processing the modem tasks within a given time period, a real time operating system (RTOS) can be optionally used to speed data processing.

In some embodiments, data exchange methods between the host computer 20 and the radio device 22 include memory mapping and share memory method. Control signals are typically exchanged using the memory mapping method according to a first in first out (FIFO) order. Data signals are typically exchanged using the share memory method. A peripheral bridge interface of the radio device 22 transmits an interrupt signal along with the data signals to the host computer 20, the upper layer software of the host computer performs the modem tasks to obtain computation results. The computation results are transmitted to and stored in the radio device 22 within a given time period, to prevent communication disconnects between the radio device and the base station.

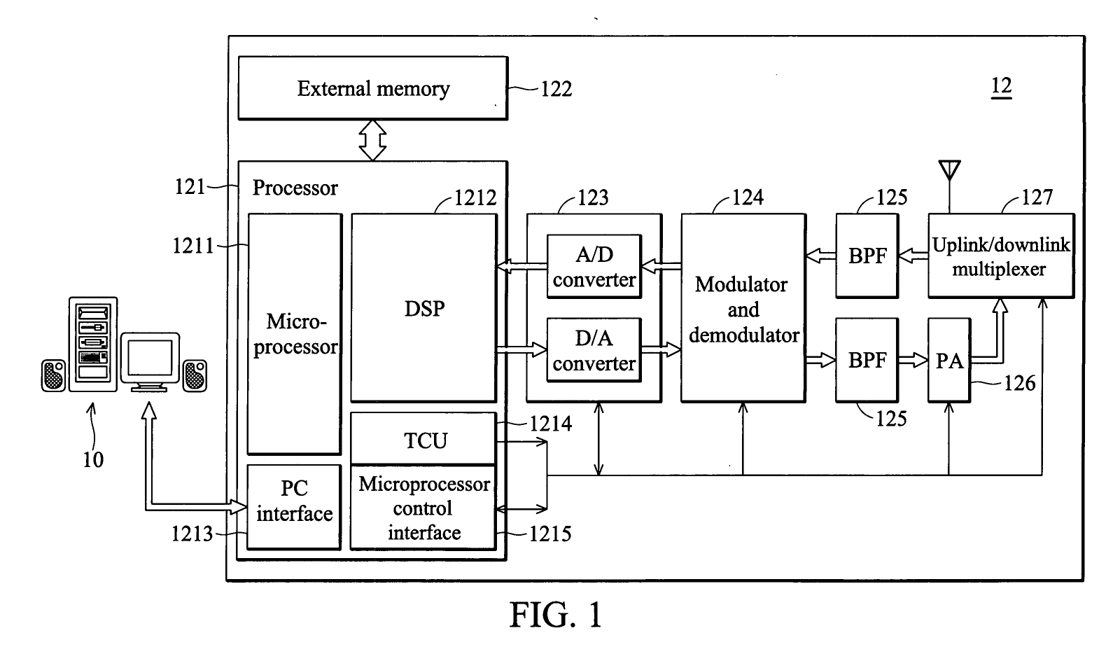

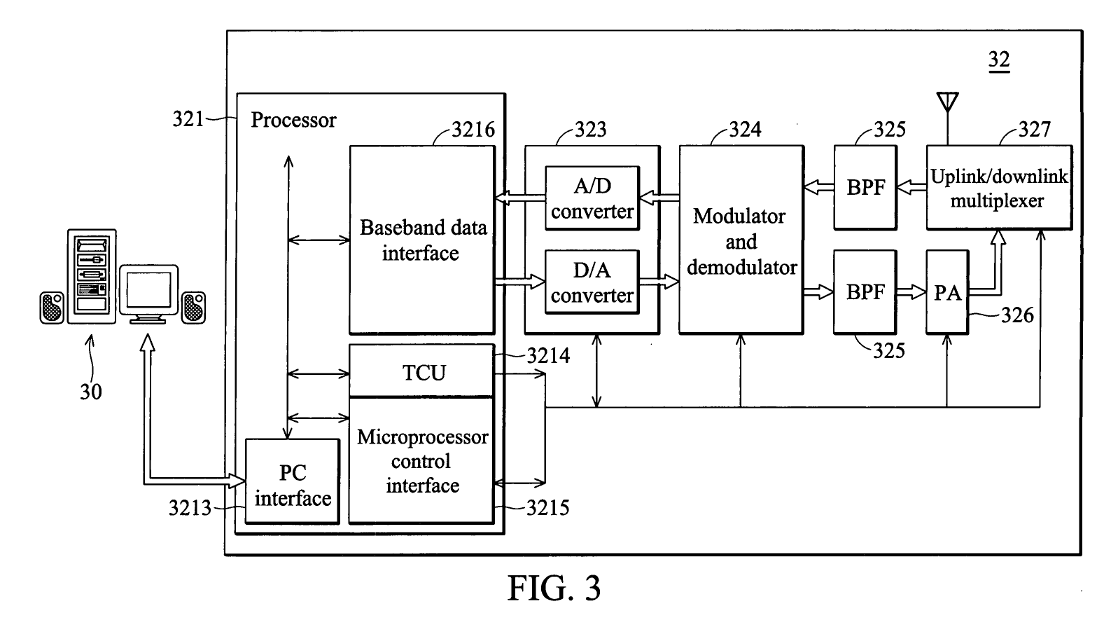

FIG. 3 shows a hardware configuration of an embodiment of a data communication system. A processor 321 in a radio device 32 comprises a PC interface 3213, a TCU 3214, a μP control interface 1215, and a baseband data interface 3216. Compared to the system shown in FIG. 1, the external memory 122, microprocessor 1211, and DSP 1212 of the radio device 12 are no longer required by the radio device 32 since tasks originally performed by the DSP 1212 and microprocessor 1211 are accomplished by the processor of the host computer 30, and the external memory 122 is replaced by the memory of the host computer 30. The processor 321 in FIG. 3 mainly comprises interfaces for exchanging the RF control signals and baseband data signals between the host computer 30 and the radio device 32. The μP control interface 3215 controls elements of the radio device 32 such as A/D and D/A converters 323, modulator/demodulator 324, PA 326, and uplink/downlink multiplexer 327. The μP control interface 3215 is typically implemented by a serial port, I2C, or input/output port. The PC interface 3213 exchanges data wrapped in packets with the host computer 30, and some embodiments of the PC interface comprise USB, UART, and PCMCIA.

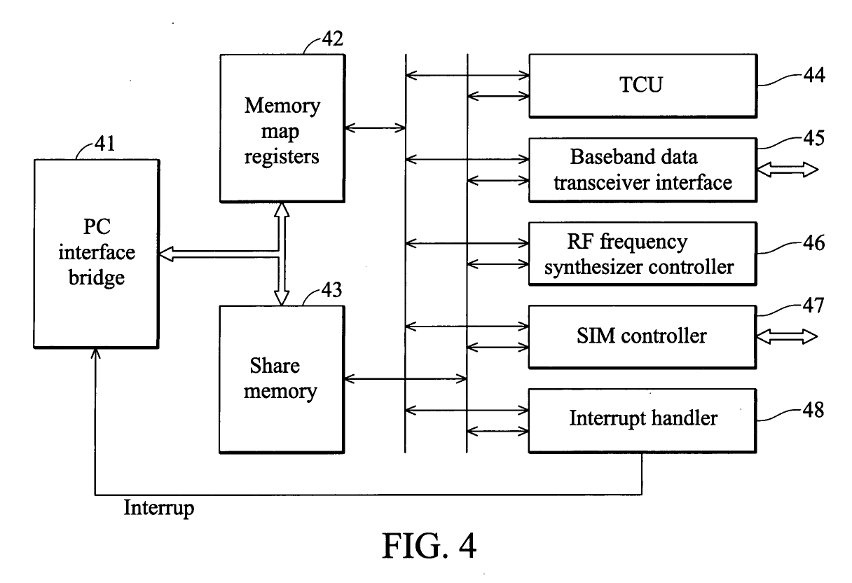

FIG. 4 shows an embodiment of a processor in a radio device. The processor comprises a PC interface bridge 41, memory map registers 42, a share memory 43, a TCU 44, a baseband data transceiver interface 45, a RF frequency synthesizer controller 46, a SIM controller 47, and an interrupt handler 48. The PC interface bridge 41 transmits an interrupt signal to a connected host computer, and also provides a data path for the host computer to access the memory map registers 42 and the share memory 43. The memory map registers 42 stores control signals and the hardware driver of the host computer controls the data exchange according to the control signals. The data throughput of the baseband data received by the radio device may exceed the transmission capacity between the host computer and the radio device, thus the share memory 43 buffers the excess baseband data before transmission to the host computer through the PC interface bridge 41. Similarly, the share memory 43 also buffers data received from the host computer until receiving a corresponding control signal to direct the data to be sent.

The TCU 44 regulates the timing between the radio device and the base station. The TCU 44 also requires generation of an interrupt signal at an appropriate time triggering the host computer to initiate data exchange and task processing according to the content of the interrupt signal. Some real time RF control signals can also be controlled by the TCU 44. The baseband data transceiver interface is responsible for receiving and transmitting the baseband signals, which accesses the data stored in the share memory 43. The RF frequency synthesizer controller 46 is responsible for transmitting control signals related to the RF modulator and demodulator. The SIM controller 47 is controlled by the host computer to transmit the data recorded in the SIM card. The Interrupt handler 48 is responsible for maintaining the queue of the interrupt signals. The interrupt signals may be generated by the TCU 44 or other controllers, and the content of the interrupt signal includes status information so that the host computer may determine which type of computation requires processing according to the status information. The host computer monitors the data output from the PC interface bridge 41, and determines the data processing priority according to the status information of the interrupt signal. The resources of the host computer are allocated to provide instantaneous processing to the data transmitted from the radio device in order to obtain computation results. The host computer sends the computation results to the radio device through the PC interface bridge 41 within a given time period.

Data communication systems and methods may greatly reduce the hardware and costs of the wireless RF modem (radio device) as the microprocessor, DSP, and the external memory of the wireless RF modem can be omitted. Complicated communication computations and tasks originally processed in the wireless RF modem are now processed in the host computer typically with greater computation and memory capacities.

In some embodiments, a radio device further comprises a mode selector, a DSP, and a microprocessor. A host computer accesses the Internet by connecting to the radio device. Modem tasks such as protocol tasks, L1 tasks, and DSP tasks are either processed by the DSP and microprocessor in the radio device or the DSP and processor in the host computer. The mode selector determines whether the modem tasks should be processed within the radio device or passed to the host computer. The mode selector can be implemented by a switch, allowing the raw data received by the processor of the radio device to bypass the DSP and microprocessor of the radio device when the modem tasks need to be processed in the host computer. The mode selector may be controlled by the user or the mode may be selected according to a current computation loading of the radio device.

While the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A data communication method for a host computer, comprising:
receiving an interrupt signal, radio frequency (RF) control signals, and baseband data signals from a radio device coupled to the host computer;
interrupting current computations to process modem tasks for the received signals and perform relevant computation operations to obtain computation results upon receiving the interrupt signal; and
transmitting the computation results to the radio device.

2. The data communication method according to claim 1, wherein the modem tasks comprise DSP tasks, layer 1 tasks, and protocol tasks.

3. The data communication method according to claim 1, further comprising exchanging data between the host computer and the radio device using a share memory mechanism.

4. The data communication method according to claim 3, wherein the exchanged data comprises the baseband data signals and the computation results.

5. The data communication method according to claim 1, further comprising exchanging control signals between the host computer and the radio device using a memory map mechanism.

6. The data communication method according to claim 1, wherein the radio device operates a cellular technology to receive and transmit signals.

7. A data communication system, comprising:
a radio device, receiving and transmitting signals based on a cellular technology, performing signal processing to obtain radio frequency (RF) control signals and baseband data signals, and generating an interrupt signal; and
a host computer coupled to the radio device, receiving the interrupt signal, RF control signals and baseband data signals from the radio device, interrupting current computations to process modem tasks for the received signals and perform relevant computation operations to obtain computation results upon receiving the interrupt signal, and sending the computation results to the radio device.

8. The data communication system according to claim 7, wherein the modem tasks comprise DSP tasks, layer 1 tasks, and protocol tasks.

9. The data communication system according to claim 7, wherein the host computer and the radio device exchange data using a share memory mechanism.

10. The data communication system according to claim 9, wherein the exchanged data comprises the baseband data signals and the computation results.

11. The data communication system according to claim 7, wherein the host computer and the radio device exchange control signals using a memory map mechanism.

12. The data communication system according to claim 7, wherein the cellular technology is Global System for Mobiles (GSM).

13. The data communication system according to claim 7, wherein the cellular technology is General Packet Radio Service (GPRS).

14. The data communication system according to claim 7, wherein the cellular technology is Code Division Multiple Access (CDMA).

15. The data communication system according to claim 7, wherein the radio device is a mobile phone.
